(19) United States
(12) Patent Application Publication
(10) Pub. No.: US 2022/0371946 A1
(43) Pub. Date: Nov. 24, 2022

(54) LASER COOLING OF SILICA GLASS

(71) Applicant: UNM RAINFOREST INNOVATIONS, Albuquerque, NM (US)

(72) Inventors: Mansoor SHEIK-BAHAE, Albuquerque, NM (US); Arash MAFI, Albuquerque, NM (US); Mostafa PEYSOKHAN, Albuquerque, NM (US); Esmaeil MOBINI SOUCHELMAEI, Albuquerque, NM (US); Saeid ROSTAMI, Albuquerque, NM (US)

(21) Appl. No.: 17/770,678

(22) PCT Filed: Oct. 20, 2020
(86) PCT No.: PCT/US2020/056523

§ 371 Date: Apr. 21, 2022

Related U.S. Application Data
(60) Provisional application No. 62/924,479, filed on Oct. 22, 2019.

(51) Int. Cl. C03C 13/04; H01S 3/04; H01S 3/17; H01S 3/16

(52) U.S. Cl. CPC C03C 13/045; H01S 3/0408; H01S 3/176; H01S 3/1618; C03C 2201/36

(57) ABSTRACT

A system, device, and method for laser cooling rare earth doped silica glass using anti-Stokes fluorescence is disclosed. The system includes a rare earth doped and codoped with one or more codopants silica glass; a laser that provides radiation to a first surface and through a body of the rare earth doped silica glass, wherein the laser is tuned from a first wavelength to a second wavelength; and a thermally sensitive device that captures images of the rare earth doped silica glass as the laser is tuned and determines a third wavelength between the first wavelength and the second wavelength where the rare earth doped silica glass is maximumly or near maximumly cooled.

### CROSS-REFERENCE TO RELATED APPLICATIONS

This application claims priority to provisional U.S. Provisional Application No. 62/924,479 filed on Oct. 22, 2019, the disclosure of which is hereby incorporated by reference in its entirety.

### GOVERNMENT RIGHTS

This disclosure was made with Government support under Contract No. FA9550-16-1-0362 awarded by United States Air Force (USAF)/Air Force Office of Scientific Research (AFOSR). The Government has certain rights in the invention.

### FIELD

The present teachings generally relate to laser cooling of silica glass.

### BACKGROUND

In solid-state laser cooling, anti-Stokes fluorescence removes heat from the material, resulting in net refrigeration. Pringsheim first proposed it in 1929 and Epstein et al. reported its first experimental confirmation in Yb-doped ZBLAN in 1995. Multiple experiments have since confirmed solid-state laser cooling; they have focused on three broad classes of solids: crystals, semiconductors, and glasses. Laser cooling of crystals has been the most successful so far; the record cooling to 91K of a 10 mol % Yb:YLF crystal was reported at the University of New Mexico in 2016. The only reported laser cooling of semiconductors is that of a CdS nanobelt in 2013 by 40K, but the validity of their results has been questioned recently. Several glasses have been successfully cooled since the first experimental report by Epstein et al. However, attempts to cool silica glass, which is arguably the most versatile optical material, have so far been unsuccessful.

The perennial failure in the laser cooling of silica glass led some to even question its possibility; the main skepticism focused on whether it would be possible for the Yb-doped silica glass to have a sufficiently small non-radiative decay rate of the Yb excited-state population to achieve a near-unity internal quantum efficiency. This was examined recently in a spectroscopic study of the Yb-doped silica glass and by looking into the potential decay channels of the Yb excited-state population; it was concluded that there is no a priori reason to reject the possibility of laser cooling for the high-purity Yb-doped silica glass. However, it was predicted that for an improved laser cooling, the glass host must be co-doped with modifiers such as Al, to mitigate the quenching-induced non-radiative decay. Advancements in solid-state laser cooling may eventually lead to all-optical compact and vibration-free cryocoolers that can reduce the thermal noise in semiconductor-based single-photon detectors or quantum information processing circuits. Another application is for radiation-balanced fiber lasers (RBFLs), where the cooling from anti-Stokes fluorescence offsets the waste heat generation in the laser. Rare-earth-doped crystals like Yb:YLF have proven to be the best materials of choice for laser cooling because they have a small inhomogeneous broadening of the absorption lines and a high ion solubility that leads to a higher cooling efficiency. However, the incompatibility of doped crystals with silicon-based devices may limit their potential applications. ZBLAN glass is another successful cooling-grade material, but its low mechanical and chemical stability limits its application for silicon photonics or RBFLs. On the other hand, Yb-doped silica glass is the material of choice for high-power fiber lasers and is commonly used as the substrate in silicon photonics. Therefore, potential applications, especially for RBFLs in the near-term and photonic-device cooling in the long-run, are strong motivations for the laser cooling of silica glass beside the scientific curiosity.

### SUMMARY

In accordance with examples of the present disclosure, a device is disclosed that comprises a ytterbium-doped silica glass that is laser cooled using anti-Stokes fluorescence and doped with one or more codopants and with a ytterbium density of up to including 4 wt %.

Various additional features of the device can include one or more the following features. The ytterbium -doped silica glass is laser cooled at a wavelength of about 1020 nm to about 1100 nm. The ytterbium -doped silica glass has an external quantum efficiency of at least 97% to allow for laser cooling. The one or more codopants comprise aluminum (Al), fluorine (F), phosphorus (P), cerium (Ce), germanium (Ge), or tin (Sn). The codopants are grouped in a first group of Al and P, a second group of Al and F, and a third group of Al, F, and Ce, and all other combinations and subcombinations, and including germanium (Ge) and tin (Sn).

In accordance with examples of the present disclosure, a method for laser cooling rare earth doped silica glass using anti-Stokes fluorescence is disclosed. The method comprising: providing radiation from a laser at an appropriate wavelength to a first surface and through a body of the rare earth doped silica glass, wherein the rare earth doped silica glass is doped with one or more codopants.

Various additional features of the method can include one or more the following features. The continuous wave laser is tuned by: tuning the laser from a first wavelength to a second wavelength; monitoring the rare earth doped silica glass using a thermally sensitive device during the tuning; and determining a third wavelength between the first wavelength and the second wavelength where the rare earth doped silica glass is maximumly or near maximumly cooled based on the monitoring. The thermally sensitive device comprises a thermal camera or a thermometer or other methods of the temperature measurement. The one or more rare earth elements comprise cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y). The one or more rare earth elements is ytterbium with a density of up to including 4 wt %. The rare earth-doped silica glass with ytterbium has an external quantum efficiency of at least 97% to allow for laser cooling. The codopants are grouped in a first group of Al and P, a second group of Al and F, and a third group of Al, F, and Ce, and all other combinations and subcombinations, and including germanium (Ge) and tin (Sn).

In accordance with examples of the present disclosure, a method for laser cooling rare earth doped silica glass using anti-Stokes fluorescence is disclosed. The method comprises providing radiation from a laser to a first surface and through a body of the rare earth doped and codoped with one or more codopants silica glass; tuning the laser from a first wavelength to a second wavelength; monitoring the rare earth doped silica glass using a thermally sensitive device during the tuning; and determining a third wavelength between the first wavelength and the second wavelength where the rare earth doped silica glass is maximumly or near maximumly cooled based on the monitoring.

Various additional features of the method can include one or more the following features. The silica glass is doped with one or more rare earth elements comprising cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y). The one or more codopants comprise aluminum (Al), fluorine (F), phosphorus (P), cerium (Ce), germanium (Ge), or tin (Sn). The first wavelength is around 1020 nm and the second wavelength is around 1100 nm. The rare earth dopant comprises ytterbium (Yb) doped at up to including 4 wt %. The method further comprises redirecting the radiation to a second surface of the rare earth doped silica glass. The rare earth doped silica glass is arranged in a vacuum chamber and reduced to a pressure of about 10⁻⁶ torr. The rare earth doped silica glass is arranged in a multiple-pass or long path absorption cell. The rare earth doped silica glass is arranged in a Herriott-type multipass cell.

In accordance with examples of the present disclosure, a system for laser cooling rare earth doped silica glass using anti-Stokes fluorescence is disclosed. The system comprises a rare earth doped and codoped with one or more codopants silica glass; a laser that provides radiation to a first surface and through a body of the rare earth doped silica glass, wherein the laser is tuned from a first wavelength to a second wavelength; and a thermally sensitive device that captures images of the rare earth doped silica glass as the laser is tuned and determines a third wavelength between the first wavelength and the second wavelength where the rare earth doped silica glass is maximumly or near maximumly cooled.

Various additional features of the method can include one or more the following features. The silica glass is doped with one or more rare earth elements. The one or more rare earth elements comprise cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y). The one or more codopants comprise aluminum (Al), fluorine (F), phosphorus (P), cerium (Ce), germanium (Ge), or tin (Sn). The first wavelength is about 1020 nm and the second wavelength is 1100 nm. The rare earth dopant comprises ytterbium (Yb) doped at up to including 4 wt %. The system further comprises a vacuum chamber that is reduced to a pressure of about 10⁻⁶ torr. The system further comprises a multiple-pass or long path absorption cell. The system further comprises a Herriott-type multipass cell.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. In the figures:

FIG. 1A and FIG. 1B show a schematic of the LITMoS system 100 according to examples of the present disclosure, where FIG. 1A shows a top view of the system and FIG. 1B shows a close up of the sample being cooled.

FIG. 2A, FIG. 2B, and FIG. 2C shows a plot of the measurement of the cooling efficiency, where dots 205 with error-bars represent the measured values of the cooling efficiency for samples A, B, and C, respectively, and the curved line 210 is a fitting of Eq. 1 to the experimental measurements.

FIGS. 3A-3F show thermal camera images of the samples, where FIG. 3A, FIG. 3C, and FIG. 3E show the thermal images of the samples A, B and C, respectively, before they are exposed to the laser light and FIG. 3B, FIG. 3D, and FIG. 3F show the thermal images of the samples A, B and C, respectively, when they are cooled by the high-power λₚ=1053 nm laser.

FIG. 4 shows a plot of temporal cooling behavior of the samples. The temperature changes of the samples A, B, and C as a function of time, respectively, when exposed to the Nd:YLF laser. The lines 405 represent the experimental results and the lines 410 represent the fitting of the exponential function in Eq. 6 to the experimental data. The obtained ΔTₘₐₓ and ηₑₓₜ parameters from fitting are presented in Table. II.

FIG. 5 shows the multi-phonon non-radiative decay rates of silica and ZBLAN (ZrF₄-BaF₂-LaF₃-AlF₃-NaF) glasses versus the energy gaps of the doped ions at T=300 K, using the parameters shown in Table III.

FIGS. 6A, 6B, and 6C show plots of normalized spectral density of the samples. The vertical dashed line 605 represents the mean fluorescence wavelength (λ_{ƒ}), where FIG. 6A shows the normalized spectral density for sample A versus pump wavelength with λ_{ƒ}^{B}=1010 nm, FIG. 6B shows the normalized spectral density for sample B with λ_{ƒ}^{B}=1008 nm, and FIG. 6C shows the normalized spectral density for sample C with λ₇₁ ^{C}=1008 nm.

FIG. 7A, FIG. 7B, and FIG. 7C show plots of an estimation of ΔT versus the laser wavelength.

FIG. 8 shows a silicon photonics and electronics circuits cooler according to examples of the present disclosure.

FIG. 9 shows a radiation balanced fiber amplifier according to examples of the present disclosure.

FIG. 10 shows a radiation balanced fiber laser according to examples of the present disclosure.

### DETAILED DESCRIPTION

Section I: Description of Device, System, and Method

Generally speaking, examples of the present disclosure provide for laser cooling. Laser cooling of a solid is achieved when a coherent laser illuminates the material in the red tail of its absorption spectrum, and the heat is carried out by anti-Stokes fluorescence of the blue-shifted photons. Solid-state laser cooling has been successfully demonstrated in several materials, including rare-earth-doped crystals and glasses. Silica glass, being the most widely used optical material, has so far evaded all laser cooling attempts. In addition to its fundamental importance, many potential applications can be conceived for anti-Stokes fluorescence cooling of silica. These potential applications range from the substrate cooling of optical circuits for quantum information processing and cryogenic cooling of mirrors in high-sensitivity interferometers for gravitational wave detection to the heating reduction in high-power fiber lasers and amplifiers. Here the net cooling of high-purity Yb-doped silica glass samples that are primarily developed for high-power fiber laser applications are described, where special care has been taken in the fabrication process to reduce their impurities and lower their parasitic background loss. The non-radiative decay rate of the excited state in Yb ions is very small in these glasses due to the low level of impurities, resulting in near-unity quantum efficiency. The measurement of the cooling efficiency as a function of the laser wavelength is described, from which the quantum efficiency of the silica glass is calculated.

In solid-state laser cooling, anti-Stokes fluorescence removes heat from the material, resulting in net refrigeration. Pringsheim first proposed it in 1929 and Epstein et al. reported its first experimental confirmation in Yb-doped ZBLAN in 1995. Multiple experiments have since confirmed solid-state laser cooling; they have focused on three broad classes of solids: crystals, semiconductors, and glasses. Laser cooling of crystals has been the most successful so far; the record cooling to 91K of a 10 mol % Yb:YLF crystal was reported at the University of New Mexico in 2016. The only reported laser cooling of semiconductors is that of a CdS nanobelt in 2013 by 40K, but the validity of their results has been questioned recently. Several glasses have been successfully cooled since the first experimental report by Epstein et al. However, attempts to cool silica glass, which is arguably the most versatile optical material, have so far been unsuccessful. Here, the laser cooling of Yb-doped silica glass is described.

The wavelength dependence of the cooling efficiency of Yb-doped silica glass samples are determined as a function of the pump laser wavelength to observe their transition from the heating to cooling regime. The cooling efficiency, η_{c}, is defined as the net power density (per unit volume) extracted from the material (ρₙₑₜ) per unit power density absorbed or scattered (ρ_{abs}): η_{c}=ρₙₑₜ/ρ_{abs}. The cooling efficiency can be expressed as (see Sections II-IX)

$${η}_{c} ( {λ}_{p} ) = \frac{{λ}_{p}}{{λ}_{f}} {η}_{ext} {η}_{a b s} - 1 \qquad ( 1 )$$

where λ_{ƒ} is the mean wavelength of the escaped fluorescence, λₚ, is the laser pump wavelength, ηₑₓₜ is the external quantum efficiency, and η_{abs} is the absorption efficiency; they are defined as

$${η}_{ext} = \frac{{η}_{e} {W}_{r}}{{W}_{tot}} , {W}_{tot} = {η}_{e} {W}_{r} + {W}_{nr} \qquad ( 2 )$$

$${η}_{a b s} ( {λ}_{p} ) = \frac{{α}_{r} ( {λ}_{p} )}{{α}_{r} ( {λ}_{p} ) + {α}_{b}} \qquad ( 3 )$$

where Wᵣ, and Wₙᵣ, are radiative, non-radiative, and total decay rates of the excited state, respectively, and ηₑ is the fluorescence extraction efficiency. α_{b} is the background absorption coefficient and αᵣ is the resonant absorption coefficient. In practice, both ηₑₓₜ and η_{abs} must be very close to unity to observe laser cooling, because λₚ cannot be much longer than λ_{f} to keep αᵣ(λₚ) sufficiently large for a near-unity value of η_{abs}.

It was recently shown that it is possible for the Yb excited-state population to have a small non-radiative decay rate in a silica glass host, i.e. Wₙᵣ«Wᵣ. Therefore, the external quantum efficiency can be near unity as long as ηₑ≈1. To revisit the arguments presented in the article “Spectroscopic investigation of Yb-doped silica glass for solid-state optical refrigeration” by Mobini, E., Peysokhan, M., Abaie, B., Hehlen, M. P. & Mafi, A. in Phys. Rev. Applied 11,014066 (2019), note that the non-radiative decay rate, Wₙᵣ, can be divided into two separate parts: the multiphonon decay rate (Wₘₚ) and the sum of other non-radiative decay rates (Wᵢ) for those channels that are related to the concentration quenching effect, i.e., Wₙᵣ=WₘₚΣᵢWᵢ. Using the energy-gap law, the multiphonon decay rate of silica glass is shown to be Wₘₚ^{silica}≈10⁻⁸s⁻¹, while that of ZBLAN is Wₘₚ^{ZBLAN}≈10⁻⁴s⁻¹; therefore, as far as the multiphoton non-radiative decay rate is concerned, Yb-doped silica glass is a better material than ZBLAN for optical refrigeration.

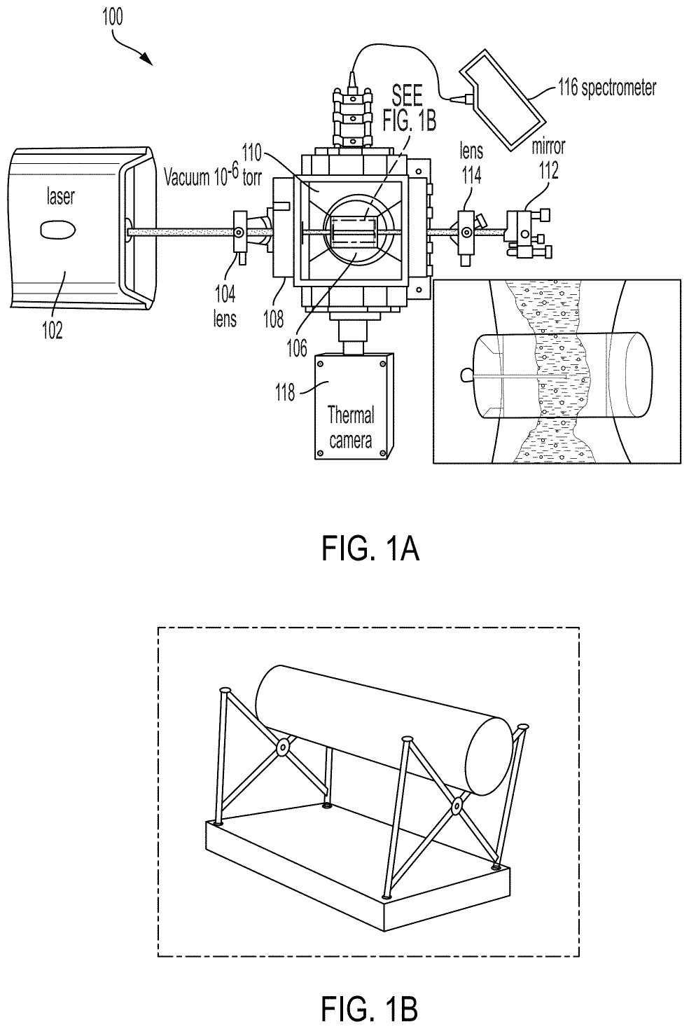

FIG. 1A and FIG. 1B show a schematic of the LITMoS system 100 according to examples of the present disclosure. Laser 102, such as a wavelength-tunable CW Ti:Sapphire laser, is coupled by lens 104, such as a lens of focal length f=10 cm, into rare-earth doped silica glass 106, such as silica glass preform A, B, C or other rare-earth and co-doped silica glass described herein, through side window 108 mounted on vacuum chamber 110. In some examples, rare-earth doped silica glass 106 can be arranged within a multiple-pass or long path absorption cell, such as a Herriott-type multipass cell. Laser-induced cool can be produced by at least one laser beam traversal through the rare-earth silica glass. In some examples, the transmitted light gets reflected back by mirror 112, such as a highly-reflective mirror, and is coupled back into rare-earth doped silica glass 106 again by lens 114, such as a lens of focal length f=10 cm. The more the laser beam traverses through the rare-earth doped silica glass, the larger the laser-induced cooling is produced. Spectrometer 116 and/or thermal measuring device or thermally sensitive device 118, such as a thermal camera as shown in FIG. 1A, a thermometer, or other methods of the temperature measurement, can be used to determine a range of wavelengths at which the rare-earth doped silica glass is cooled. The lower left inset shows a sketch of the Yb-doped silica glass preform supported by a set of thin silica fibers to minimize the heat load, while the lower right inset shows the actual image of preform supported on the thin silica fibers.

In one non-limiting example, rare-earth doped silica glass 106 can be a ytterbium-doped silica glass that is laser cooled using anti-Stokes fluorescence and doped with one or more codopants and with a ytterbium density of up to including 4 wt %. The ytterbium-doped silica glass is laser cooled at a wavelength of about 1020 nm to about 1100 nm. The ytterbium-doped silica glass has an external quantum efficiency of at least 97% to allow for laser cooling. The one or more codopants comprise aluminum (Al), fluorine (F), phosphorus (P), cerium (Ce), germanium (Ge), or tin (Sn). The codopants can be grouped in a first group of Al and P, a second group of Al and F, a third group of Al, F, and Ce, and additional grouping that include all other combinations and subcombinations, and including germanium (Ge) and tin (Sn).

In another non-limiting example, rare-earth doped silica glass 106 can be doped with one or more rare-earth elements and can be codoped with include one or more codopants. The one or more rare earth elements comprise cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y). The one or more codopants comprise aluminum (Al), fluorine (F), phosphorus (P), cerium (Ce), germanium (Ge), or tin (Sn). In the example of ytterbium (Yb), the rare earth dopant comprises ytterbium (Yb) doped at up to including 4 wt %. The codopants can be grouped in a first group of Al and P, a second group of Al and F, a third group of Al, F, and Ce, and additional grouping that include all other combinations and subcombinations, and including germanium (Ge) and tin (Sn).

The non-radiative decay channels related to the concentration quenching are mainly due to the dipole-dipole interactions between Yb ions and impurities, which include OH—, transition metals, and undesirable rare-earth ions; as well as Yb-Yb interactions in Yb ion clusters. Developing a high-purity Yb-doped silica glass is therefore required to avoid the interactions between the Yb ions and impurities. Additionally, to ensure that Yb ion clustering is suppressed and to further mitigate Yb-impurity interactions, it is imperative for the Yb ion density to remain below the critical ion concentration. It is known that the ion solubility of the silica glass is quite low, i.e., for pure silica glass the critical quenching concentration is N_{c}1025 m⁻³ or lower. However, by using modifiers such as Al and P, the quenching concentration of silica glass can be increased by an order of magnitude. To prevent concentration quenching and achieve ηₑₓₜ≈1, it is necessary to keep the Yb ion density below N_{c}. Quite possibly, this issue has been one of the main reasons behind the previously failed attempts in laser cooling of the Yb-doped silica glass. The Yb-doped silica glass samples that are studied in this Letter are all high-purity and are doped with modifiers to increase the Yb ion solubility. The parasitic background absorption (αb) in these glasses is sufficiently low to ensure that η_{abs}≈1, as is required to achieve laser cooling.

For the laser cooling experiments, three different samples of Yb-doped silica glass optical fiber preforms are used in experiments conducted by the inventors. These preforms are referred to as sample A, sample B, and sample C, respectively. These preforms are Yb-doped only in the core and their characteristics are listed in Table. 1.

TABLE I
Characteristics of the Yb-doped silica glass preforms.

| | | | Yb | OH⁻ | Core | Clad | Sample | α_{b} |
|---|---|---|---|---|---|---|---|---|
| | | Yb₂O₃ | density | conc. | diam. | diam. | length (l) | (1200 nm) |
| Sample | Codopants | [mol %] | [10²⁵ m⁻³] | [ppm] | [mm] | [mm] | [mm] | [dB km⁻¹] |
| A | Al, P | 0.12 | 5.3 | 3.0 | 1.7 | 10.7 | 28.6 | 10 |
| B | Al, F | 0.10 | 4.4 | 1.5 | 2.6 | 13.8 | 28.7 | 9 |
| C | Al, F, Ce | 0.13 | 5.7 | 1.5 | 3.1 | 14.8 | 27.8 | 5 |
| | Error: | ±0.01 | ±0.4 | ±0.5 | ±0.1 | ±0.1 | ±0.1 | ±2 |

To investigate laser cooling and obtain the cooling efficiency, η_{c}, of the Yb-doped silica glass preforms as a function of the laser pump wavelength, the Laser-Induced Thermal Modulation Spectroscopy (LITMoS) test is performed on all three samples (see Sections II-IX). The LITMoS test setup is shown in FIG. 1A. The samples are held by a set of silica fibers inside a vacuum chamber with the pressure of 10-6 Torr to eliminate the conductive and convective heat-loads on the samples, so the black body radiation remains the only source of heating from the environment. The samples are pumped by a wavelength-tunable continuous wave (CW) Ti-Sapphire laser (980 nm <λₚ<1070 nm) and the laser light passes through each sample twice using an external mirror. The thermal images and spectral features of the samples are captured through a set of thermally transparent KCI salt windows mounted in the chamber. The changes of the temperatures are recorded by a thermal camera. To calculate the mean fluorescence wavelength, the samples are initially pumped at λₚ=1030 nm. The fluorescence emission then is captured with an optical spectrum analyzer. The calculated mean fluorescence wavelengths of the samples A, B and C are found to be λ_{Aƒ}=1010 nm, λ_{Bƒ}=1008 nm, and λA_{Cƒ}=1008 nm, respectively (see Sections II-IX).

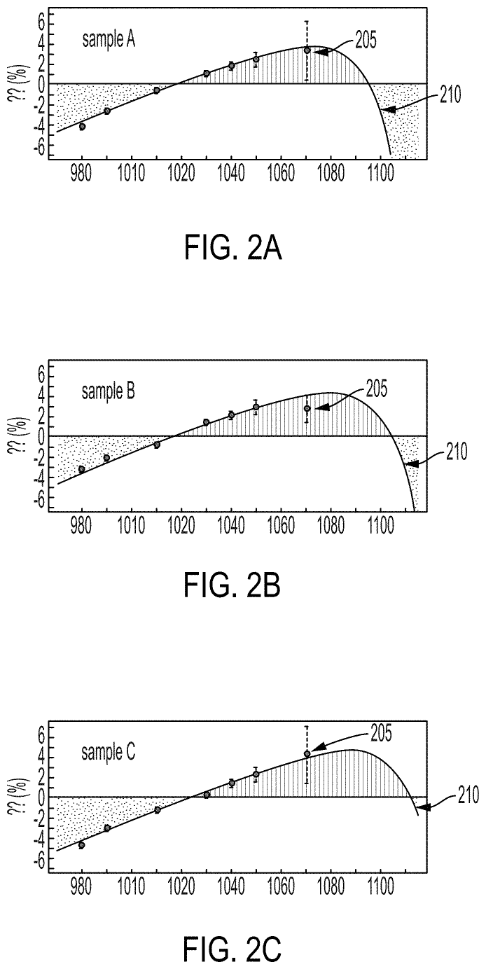

FIG. 2A, FIG. 2B, and FIG. 2C shows a plot of the measurement of the cooling efficiency, where dots 205 with error-bars represent the measured values of the cooling efficiency for samples A, B, and C, respectively, and the curved line 210 is a fitting of Eq. 1 to the experimental measurements. The pump laser wavelength is gradually increased; once it becomes longer than the mean fluorescence wavelength, the anti-Stokes fluorescence begins to extract heat from the sample until the cooling efficiency becomes positive, indicating the net laser cooling. As can be seen in FIGS. 2A, 2B, and 2C, all three samples have been laser cooled. By fitting Eq. 1 to the experimental results and using the values of ab reported in Table. I, the external quantum efficiency, ηₑₓₜ, of the samples, are found, which are summarized in Table. II. Note that the lines 210 in FIG. 2A, FIG. 2B, and FIG. 2C are the results of the one-parameter fitting—the fitting procedure to determine the values of αb can be used as well. However, the lack of experimental data for η_{c} at wavelengths above 1070 nm results in large uncertainties in αb; therefore, it was chosen to use the directly-measured values in Table. I, which appear to conform well to the measurements.

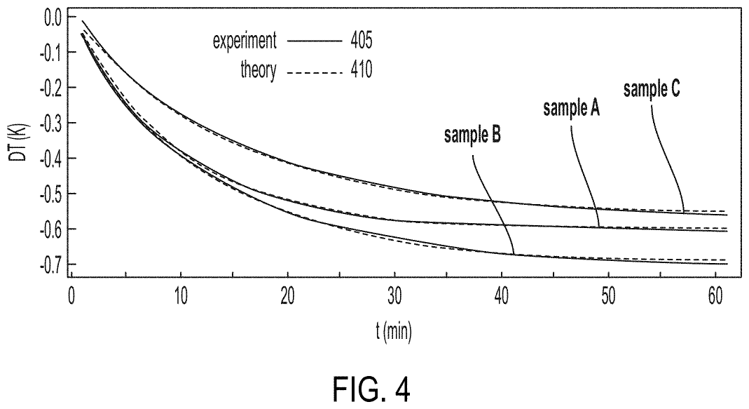

TABLE II
Results of the fitting procedures related to the LITMoS
tests presented in FIG. 2 with Eq. 1; and the temporal
evolution curves of the temperature exposed to the high-
power Nd:YLF laser presented in FIG. 4 with Eq. 6.

| | | ΔTₘₐₓ | τ_{c} | η_{c} |
|---|---|---|---|---|
| Sample | ηₑₓₜ | [K] | [s] | [%] (1053 nm) |
| A | 0.993 ± 0.003 | 0.6 | 599 | 2.2 |
| B | 0.990 ± 0.003 | 0.7 | 754 | 2.7 |
| C | 0.984 ± 0.003 | 0.56 | 915 | 2.1 |

The results of the LITMoS tests prove laser cooling in all the Yb-doped silica glass preforms. However, because in the LITMoS test setup, the maximum power of the Ti:Sapphire laser that was used in the cooling wavelength range is less than 900mW, the signal to noise ratio, as can be seen from the error-bars in FIGS. 2A-2C, is large. Therefore, to enhance and further confirm the laser cooling of the samples, the preforms were pumped with a 10.4W Nd:YLF laser, the wavelength of which at 1053 nm resides in the cooling spectral range of the samples, as shown in FIGS. 2A-2C. Similar to the LITMoS test, the samples were double-pass pumped by the Nd:YLF laser inside the vacuum chamber and the changes of the temperature were recorded by the thermal camera as a function of the exposure time.

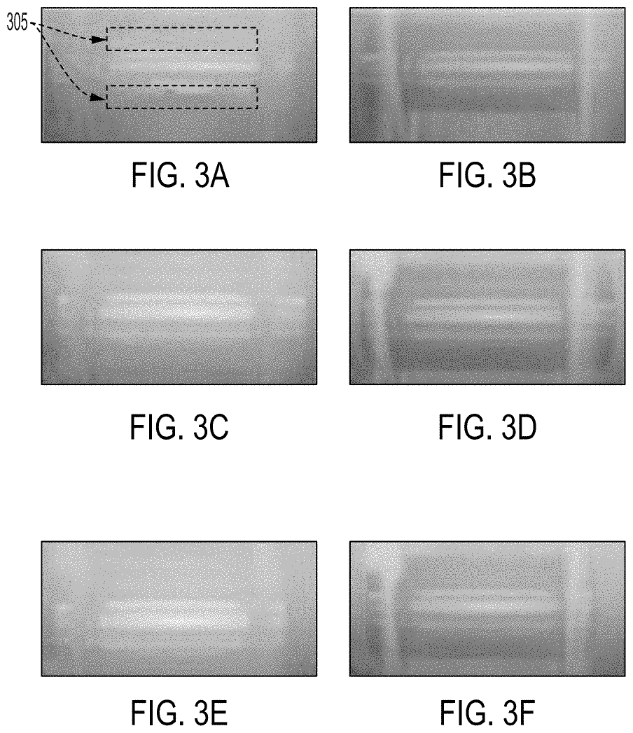

FIGS. 3A-3F show thermal camera images of the samples, where FIG. 3A, FIG. 3C, and FIG. 3E show the thermal images of the samples A, B and C, respectively, before they are exposed to the laser light and FIG. 3B, FIG. 3D, and FIG. 3F show the thermal images of the samples A, B and C, respectively, when they are cooled by the high-power Nd:YLF laser λₚ=1053 nm laser. The regions that are used in obtaining the temperature changes for the LITMoS test are marked by the dashed lines 305 in the left column. The thermal images after the exposure to the laser light were taken after the laser was turned on and the sample temperature was stabilized (˜40 minutes). Note that the heat extraction occurs only in the core of each sample, but the entire sample cools almost uniformly in less than a minute. The cooling is easily recognizable by unaided human eye when the thermal camera image become darker after the exposure to the Nd:YLF laser. The bright regions in the thermal image of the sample in FIGS. 3A-3F can be misleading; the reason for these bright regions is that silica glass is not transparent in the thermal window and the bright regions on the sample originate from reflections of the thermal radiation from the side-walls of the chamber onto the sample's cylindrical surface and eventually into the thermal camera.

FIG. 4 shows a plot of temporal cooling behavior of the samples. The temperature changes of the samples A, B, and C as a function of time, respectively, when exposed to the 10.4W Nd:YLF laser. The lines 405 represent the experimental results and the lines 410 represent the fitting of the exponential function in Eq. 6 to the experimental data. The obtained ΔTₘₐₓ and ηₑₓₜ parameters from fitting are presented in Table. II.

ΔT(t)=ΔTₘₐₓ(e^{-t}/τ_{c}−1) (4)

where the following definitions are used:

$$Δ {T}_{max} = {η}_{c} \frac{{P}_{a b s}}{4 ϵ {T}_{0}^{3} A} , {τ}_{c} = \frac{ρ V {c}_{V}}{4 ϵσ {T}_{0}^{3} A} \qquad ( 5 )$$

where Pabs is the absorbed power, ϵ=0.85 is the emissivity of the implemented Yb-doped silica glass fiber preforms, σ=5.67×10⁻⁸Wm⁻²K⁻⁴ is the Stefan-Boltzmann constant, T₀ is the ambient temperature, l is the sample length, A is the surface area of the sample, V is the volume of the sample, ρ=2.2×103 kgm⁻³ is the silica glass mass density, and cᵥ=741 Jkg⁻¹K⁻¹ is the specific heat of the silica glass.

Equations 4 and 5 can be derived by noting that in the vacuum chamber, the convective and conductive heat transfers are negligible; therefore, the temporal behavior of the temperature obeys the following differential equation

$$ρ V {c}_{V} \frac{d Δ T}{d t} \approx - {η}_{c} {P}_{a b s} - 4 ϵσ {AT}_{0}^{3} Δ T \qquad ( 6 )$$

where the absorbed power in the double-pass experiment is given by

P_{abs}=Pᵢₙ [symbol] (1−e^{-a}^{ᵣ}^{(λ}^{ₚ₎ₗ}(1+ [symbol] ²Rₘe^{-αr(λp)l)} (7)

ΔT=Tₛ−T₀, where Tₛ is the sample temperature αᵣ(λₚ) is the resonant absorption coefficient of the pump laser. We also have [symbol] =T_{w}TₗT_{g}, where T_{w}=0.92 is the transmission of the vacuum chamber windows, Tₗ=0.998 is the transmission of the lenses, T_{g}=0.96 is the transmission of the preforms' facets, and Rₘ=0.998 is the reflection of the mirror. Note that the absorption coefficients of samples A, B, and C were measured to be αᵣ(λₚ)=0.43, 0.52, and 0.50 m⁻¹, respectively. The exponential form presented in Eq. (4) is a direct solution to Eq. (6); by fitting Eq. (4) to the measurements in FIG. 4, the values of the two fitting parameters for each sample, i.e., ΔTₘₐₓΔTₘₐₓ and ηₑₓₜ (via t_{c}) are extracted and reported in Table II. It is noted that the slope of the ΔT(t) curve at t=0 in Eq. (4) gives us the value of the cooling efficiency at 1053 nm wavelength, i.e., η_{c}=−(ρVcᵥ/P_{abs})∂ₜΔT|ₜ₌₀. For each sample, the value of was also calculated using the two fitted coefficients, and present the results in Table II; these values all agree well, within the error bars, with the plots of in FIGS. 2A-2C obtained using the LITMoS

In conclusion, laser cooling in three separate bulk samples of Yb-doped silica glass optical fiber preform has been demonstrated. Each sample has a different Yb ion concentration and each is co-doped with one or more of Al, P, F, and Ce elements. A LITMoS test was performed on each sample and extracted its cooling efficiency and showed that each sample is cooled over a certain laser pump wavelength range. Separately, each sample was exposed to a high-power Nd:YLF laser at 1053 nm wavelength and monitored the temporal evolution of its temperature. The independently extracted cooling efficiencies all agree with those from the LITMoS tests, indicating a maximum cooling of the three samples by 0.6 K, 0.7 K, and 0.56 K, respectively, at 1053 nm laser pump wavelength. Because of the geometry of the samples, the temperature variation within each sample is negligible; therefore, the reported temperature drop is nearly uniform in the entire volume of each sample. The experiments also allowed us to extract the parasitic background absorption and external quantum efficiency of each sample. This is the first reported measurement of the external quantum efficiency of Yb-doped silica glass, the determination of which is critical to laser cooling experiments.

Section II: Derivation of the cooling efficiency formula

The cooling efficiency, η_{c}, is defined as the net power density (per unit volume) extracted from the material (p ₙₑₜ) per unit power density absorbed or scattered (p_{abs}): η_{c}=pₙₑₜ/p_{abs}. The net cooling power density can be written as pₙₑₜ=p_{asf}-p_{abs}, where p_{asf} is the fraction of the power density that escapes as anti-Stokes fluorescence (ASF) emission out of the material. The absorbed power density is given by p_{abs}=(αᵣ+α_{b})Iₚ, where Iₚ is the pump intensity, αᵣ is the resonant absorption coefficient of the pump laser and, α_{b} represents the parasitic background absorption. The ASF emission power escaping from the material can be described by ηₑN₂Wᵣ(hv_{f}), where v_{f} is the mean florescence frequency (v_{f}=cλ_{f}⁻¹, c is the light speed), N₂ is the ion density of the excited upper level in the quasi two-level system and, Wᵣ (Wₙᵣ) is the radiative (non-radiative) decay rate of the excited state of the doped ions. ηₑ is the extraction efficiency and 1-ηₑ is the fraction of photons which are trapped inside the host. The rate equation of the energy upper level can be expressed as

$$\frac{d {N}_{2}}{dt} = \frac{{α}_{r} {I}_{P}}{h {v}_{P}} - ( {W}_{r} + {W}_{n r} ) {N}_{2} + ( 1 - {η}_{e} ) {W}_{r} {N}_{2} \qquad S 1$$

where it is assumed that the trapped florescence finally is reabsorbed by the ions. Under steady-state condition where dN₂/dt=0, the power extracted via ASF emission can be written as p_{asf}=αᵣIₚηₑₓₜ(λₚ/λ_{f}), where the external quantum efficiency is given by ηₑₓₜ=ηₑWᵣ/(ηₑWᵣ+Wₙᵣ). We therefore have

$${p}_{n e t} = {α}_{r} {I}_{P} {η}_{e x t} ( \frac{{λ}_{P}}{{λ}_{f}} ) - ( {α}_{r} + {α}_{b} ) {I}_{P} \qquad S 2$$

which leads to

$${η}_{c} = \frac{{p}_{n e t}}{{p}_{a b s}} = \frac{{λ}_{P}}{{λ}_{f}} {η}_{ext} {η}_{a b s} ( λ ) - 1 . \qquad S 3$$

Section III: The non-radiative decay channels in Yb-doped silica glass

The internal quantum efficiency, η_{q}=Wᵣ/(Wᵣ+Wₙᵣ), is the ratio of the radiative decay to the total decay of an excited state in a medium; The non-radiative decay channels in a typical Yb-doped silica glass can be divided into a set of decay channels:

S4: Wₙᵣ=Wₘₚ+W_{OH}+W_{Yb}ΣᵢWᵢ

The partial non-radiative decay channels are as follows: Wₘₚ represents the multi-phonon decay of the Yb excited state, W_{OH}-accounts for non-radiative decay of the Yb excited state via the high-energy vibrational modes of OH⁻ impurities, WYb accounts for non-radiative decay in Yb ion clusters, and Wi represents the non-radiative decay due to interactions of the excited state with various transition-metal and rare-earth ion impurities, respectively.

The multi-phonon relaxation that originates from the coupling of the excited state with the vibrational wavefunctions of the ground state can be described by energy-gap law:

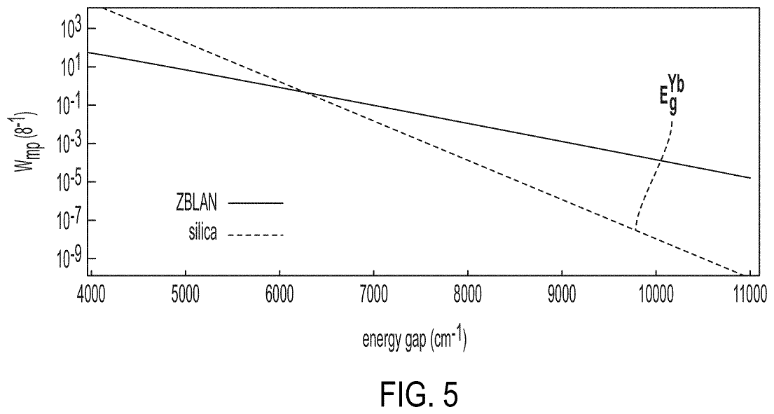

S5: Wₘₚ=Wₒe⁻⁶⁰ ^{ₕ}^{(Eg-2Ep)}

where Ep is the maximum phonon energy of the host material, and Eg is the energy gap of the dopant ion (Yb). WO and ah are phenomenological parameters, whose values strongly depend on the host-material2-5. FIG. 5 shows the multi-phonon non-radiative decay rates of silica and ZBLAN (ZrF₄-BaF₂-LaF₃-AIF₃-NaF) glasses versus the energy gaps of the doped ions at T=300 K, using the parameters shown in Table III.

TABLE III
Parameters related to Eq. S5 and FIG. 5 for silica and ZBLAN
(ZrF₄—BaF₂—LaF₃—AlF₃—NaF) glasses.

| | W₀ | αₕ | Eₚ |
|---|---|---|---|
| Host | (s⁻¹) | (cm) | (cm⁻¹) |
| Silica | 7.8 × 10⁷ | 4.7 × 10⁻³ | 1.10 × 10³ |
| ZBLAN | 1.7 × 10⁴ | 2.1 × 10⁻³ | 0.58 × 10³ |

From FIG. 5, the multi-phonon relaxation decay rate for excited-state Yb is much smaller in silica glass than in ZBLAN glass. FIG. 5 shows a plot of non-radiative decay rate of Yb in silica versus ZBLAN (ZrF₄-BaF₂-LaF₃-AIF₃-NaF) glass. Multi-phonon non-radiative decay rate (Wₘₚ) of Yb-doped ZBLAN and silica glasses versus energy gap (E_{g}) calculated from Eq. S5 and the parameters listed in Table III. Auzel et al.6 have shown that the total effect of the last three terms in Eq. S4 can be described by a phenomenological equation based on a limited diffusion process, modeled as a non-radiative dipole-dipole interaction between the ions and impurities:

$${η}_{q} ( N ) = \frac{1}{1 + \frac{9}{2 π} {( \frac{N}{{N}_{c}} )}^{q}} \qquad S 6$$

where for the glasses, e.g. silica, q≈2, N is the ion density, and N_{c} is the quenching concentration density.

Equation S6 shows that as long as N «N_{c}, the internal quantum efficiency approaches unity (η_{q}≈1). All the Yb-doped silica glass preforms implemented in the study were fabricated in such a way as to satisfy N «N_{c}, and guarantee a near-unity internal quantum efficiency.

Section IV: Temperature dynamic of cooling sample under high vacuum

Four different heat sources can contribute to the temperature changes of the cooling sample. The contribution of each heat-load on the sample can be described by

$${C}_{v} \frac{d T}{dt} = - {η}_{c} {P}_{a b s} + \frac{ϵ A σ}{1 + ϰ} ( {T}_{0}^{4} - {T}^{4} ) + A {κ}_{h} ( {T}_{0} - T ) + \frac{N {κ}_{l} {A}_{1}}{{d}_{1}} ( {T}_{0} - T ) \qquad S 7$$

where the first term represents the heat extraction from ASF cooling, the second term represents the radiative heat exchange between the cooling sample and the chamber, and the third and fourth terms represent the convective and conductive heat-loads on the cooling sample, respectively. η₇c is the cooling efficiency, P_{abs} is the absorbed power, σ is the Stephan-Boltzmann coefficient, T₀ is the ambient temperature, T is the sample temperature, X=(1-ϵ_{c})ϵA/ϵₒA_{c}, ϵ_{c} is the chamber emissivity, A_{c} is the chamber surface area, N is the number of contacting points, A_{I} is the area of contacting point, d_{I} is the length of the contacting point, K_{I} is the thermal conductivity of the sample holder, Kₕ is the convective heat transfer coefficient of the chamber and, Cᵥ=cᵥρV, where V is the sample volume and cᵥ is the heat specific coefficient.

Under high vacuum, the convective heat transfer coefficient becomes negligible8; therefore, one can ignore the contribution of the convective heat source in Eq. S7. Similarly, the conductive heat-load from the set of silica fiber holders that are used to support the sample are quite low (small N and A_{I}). In fact, it is typical for a laser cooling experiment that special care is taken to ensure that the product of K_{I}NA_{I} is small such that the contribution of the conductive part becomes negligible.

Considering the fact that the surface area of the chamber (A_{c}) is much larger than that of cooling sample (A), it is assumed that x 140 1; therefore, Eq. S7 reduces to:

$${C}_{v} \frac{d T}{dt} \approx - {η}_{c} {P}_{a b s} + ϵ A σ ( {T}_{0}^{4} - {T}^{4} ) \qquad S 8$$

Assuming that the laser cooling experiment is run in a regime where T≈T₀, which is the case in the experiments performed by the inventors, we will have (T₀⁴-T⁴) ≈4T₀³(T₀-T); hence, Eq. S8 takes the following from:

$${C}_{v} \frac{d T}{dt} \approx - {η}_{c} {P}_{a b s} - 4 ϵ A σ {T}_{0}^{3} ( T - {T}_{0} ) \qquad S 9$$

Section V: Laser-Induced Thermal Modulation Spectroscopy (LITMoS) Test

In steady state (dT/dt=0), Eq. S9 results in a relationship between the cooling efficiency, the absorbed power, and temperature changes of the sample:

$${η}_{c} ( {λ}_{P} ) = \frac{Δ T ( {λ}_{P} ) {C}_{rad}}{{P}_{a b s} ( {λ}_{P} )} \qquad S 10$$

where C_{rad}≈4ϵAσT₀³.

In the LITMoS test, once the sample temperature is stabilized, the thermal image of the sample at each pump wavelength (λₚ) is captured by a thermal camera—the thermal camera used in the study is Thermal Eye Nanocore 640. Knowing that η_{c}(λₚ) αΔT(λₚ)/P_{abs}(λₚ), after normalizing the thermal images of the sample to the absorbed power at each wavelength, using a fitting procedure, one can extract the proportionality constant and the external quantum efficiency (ηₑₓₜ). Note that at each wavelength, the spectral density (S(λ)) is used as a measure for the absorbed power in the sample as P_{abs}(λₚ) αS(λ).

Section VI: Mean fluorescence wavelength

The mean escaped fluorescence wavelength (λ_{f}) is the average wavelength associated with the average energy of an emitting photon. If it is assumed that φ(v) is the photon flux density, then the average energy of a photon that is emitted via ASF (Ē) takes the following form

$$\overline{E} = h {v}_{f} = h \frac{\int ϕ ( v ) v dv}{\int ϕ ( v ) dv} \qquad S 11$$

Considering that dv=−cdλ/λ² and (hc/λ) S(λ)=h v φ(v), where S(λ) is the spectral density, the mean fluorescence wavelength can be obtained from:

$${λ}_{f} = \frac{\int S ( λ ) λ d λ}{\int S ( λ ) d λ} \qquad S 12$$

As mentioned earlier, by pumping the silica preforms at λₚ=1030 nm, the spectral densities of the samples, S(λ), were captured by an optical spectrum analyzer (Yokogawa-AQ6319). Eq. S12 is used to calculate the mean fluorescence wavelength of each sample.

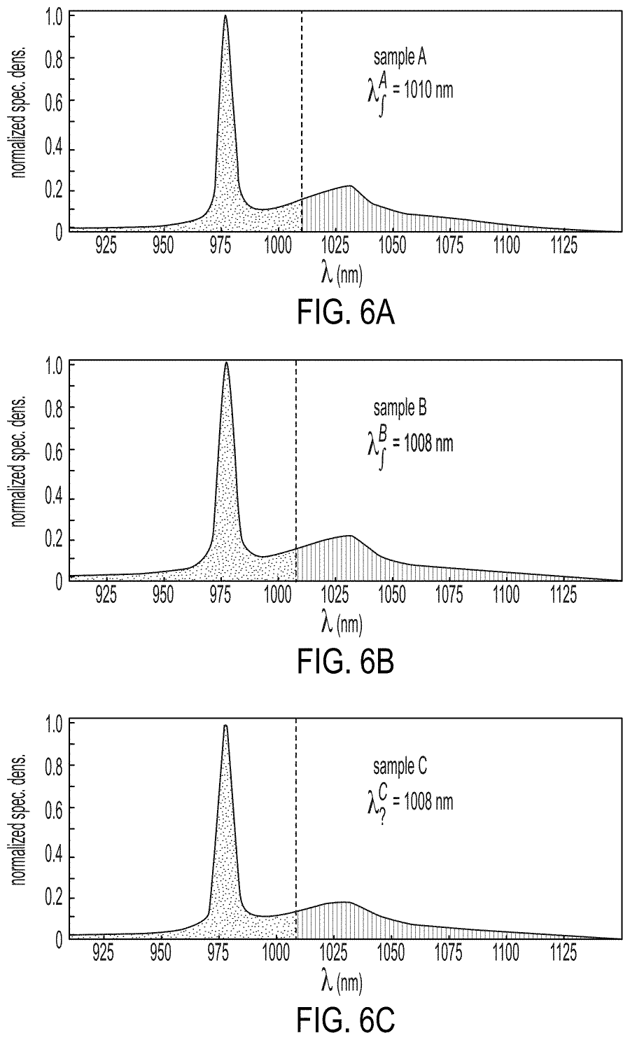

FIG. 6A, FIG. 6B, and FIG. 6C show plots of normalized spectral density of the samples. The vertical dashed line 605 represents the mean fluorescence wavelength (λ_{f}). The shaded region 610 represents λₚ>λ_{f} and the shaded region 615 represents λₚ<λ_{f}. FIG. 6A shows the normalized spectral density for sample A versus pump wavelength with λ_{f}^{A}=1010 nm, FIG. 6B shows the normalized spectral density for sample B with λ_{f}^{B}=1008 nm, and FIG. 6C shows the normalized spectral density for sample C with λ_{f}^{C}=1008 nm. The mean fluorescence wavelength of each sample is also shown in FIGS. 6A, 6B, and 6C.

Section VII: Optimum cooling wavelength

From Eq. S10, it is known that

$$Δ T = \frac{{η}_{c} {p}_{a b s}}{4 ϵ A σ {T}_{0}^{3}}$$

$$and$$

$${dp}_{abs} = {p}_{in} ( 1 - {e}^{- {α}_{r} ( {λ}_{P} ) l} ) \approx {p}_{in} {α}_{r} ( {λ}_{P} ) l$$

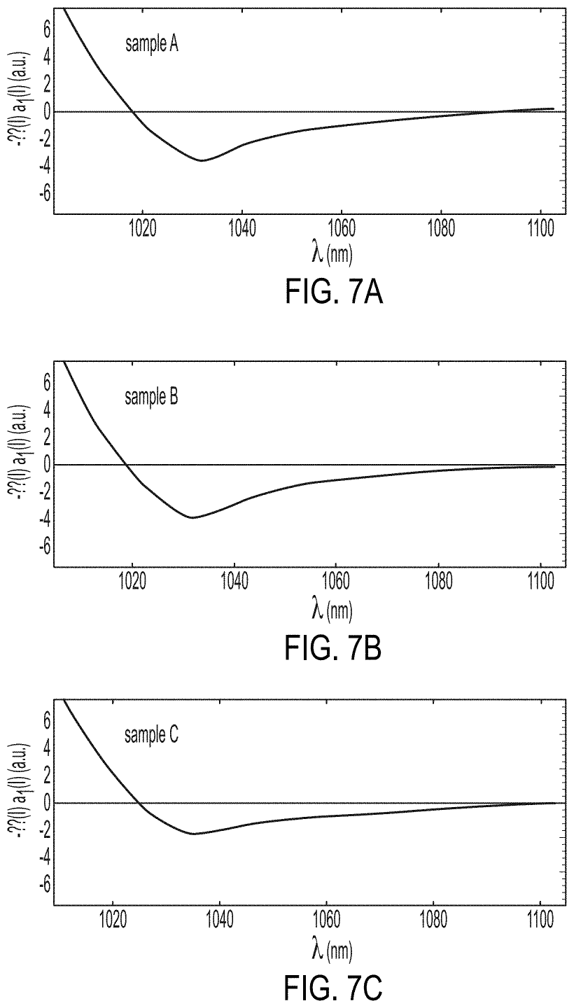

applicable for a one-pass LITMoS test. It is assumed there is no loss from different surfaces, which is a legitimate assumption in the present setup. Knowing the cooling efficiency, then the desired product (—η_{c}p_{abs}) becomes proportional to —η_{car}(λₚ). FIG. 7A, FIG. 7B, and FIG. 7C shows a plot —η_{c}αᵣ versus λₚ for each sample. These figures clearly show that the maximum temperature drop can be attained at around 1035 nm for equal value of pin. The choice of λₚ=1053 nm for the power cooling experiment was merely dictated by the availability of high-power laser source.

FIGS. 7A, 7B, and 7C show plots of an estimation of AT versus the laser wavelength. The figures show the value of —η_{c}αᵣ(λ) versus the laser wavelength for the samples A, B and C, respectively. These plots serve as an estimate of ΔT versus the laser wavelength at a fixed input laser power.

Section VIII: Effect of ambient radiation

The ambient radiation drifts basically over the experiment. For the LITMoS test, the effect of the background radiation is considered. The ambient radiation was recorded for one hour before the LITMoS test, and for one hour after the LITMoS test. Finally, for the calculation of the LITMoS test, the average value of the background thermal radiation is used that includes the drift effect too.

Section XI: Examples

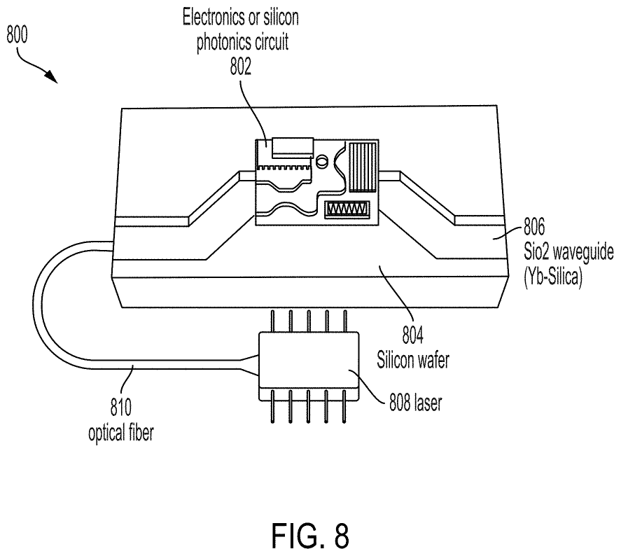

FIG. 8 shows a silicon photonics and electronics circuits cooler 800 according to examples of the present disclosure. Electronics or silicon photonics circuit 802 is mounted or formed on a top surface of silicon wafer 804. Optical waveguide 806, such as a Sio2 waveguide (Yb-silica) is formed in the body of silicon wafer 804 and under electronics or silicon photonics circuit 802. Optical waveguide 806, and thus electronics or silicon photonics circuit 802 and silicon wafer 804, is cooled by predetermined radiation from laser 808 conveyed to optical waveguide 806 by optical fiber 810. The predetermined radiation from laser 808 can be determined by the processes described herein.

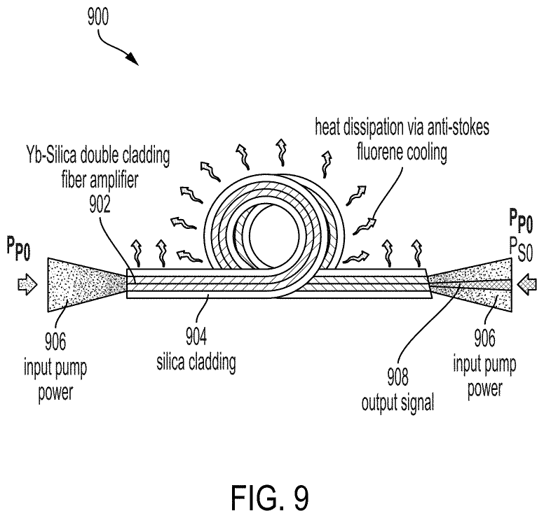

FIG. 9 shows a radiation balanced fiber amplifier 900 according to examples of the present disclosure. Yb-silica double cladding fiber amplifier 902 provides for heat dissipation via anti-Stokes fluorene cooling. Yb-silica double cladding fiber amplifier 902 comprises silica cladding 904 and heat dissipation via anti-Stokes fluorene cooling. Radiation (input pump power 906) from one or more pump lasers, denoted P_{PO} in FIG. 9, is provided to a first end and a second end of Yb-silica double cladding fiber amplifier 902. Output signal 908, denoted P_{SO} in FIG. 9, is transmitted from the second end.

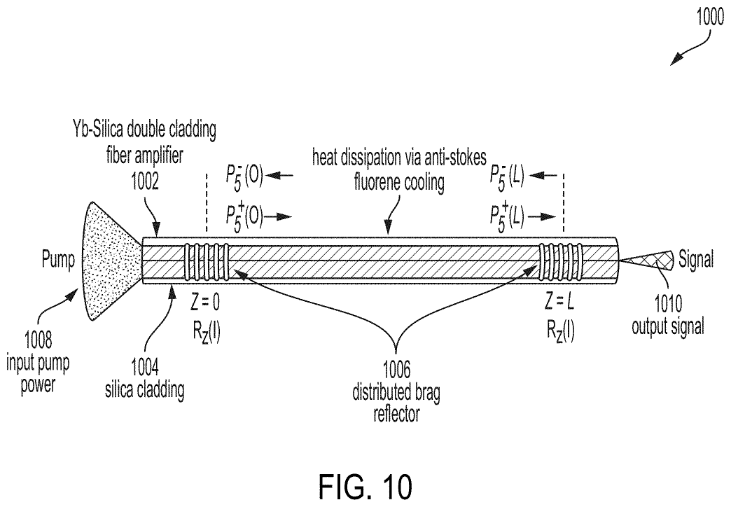

FIG. 10 shows a radiation balanced fiber laser 1000 according to examples of the present disclosure. Yb-silica double cladding fiber amplifier 1002 provides for heat dissipation via anti-Stokes fluorene cooling. Yb-silica double cladding fiber amplifier 1002 comprises silica cladding 1004 and one or more distributed Bragg reflector 1006 formed within a core of Yb-silica double cladding fiber amplifier 1002 and a length of denoted by L and a length axis denoted by Z. Radiation (input pump power 1008) from one or more pump lasers, denoted by P_{S}⁻(O), P_{S}⁺(O), P_{S}⁻(L), and P_{S}⁺(L) in FIG. 10, is provided to a first end and a second end of Yb-silica double cladding fiber amplifier 1002. The positive and negative in the superscript denoting the direction of the radiation in Yb-silica double cladding fiber amplifier 1002, where the negative is going from the right to the left in FIG. 10 and the positive the reverse. Output signal 1010 is transmitted from the second end.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or implementations of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B, means A alone, B alone, or A and B. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated implementation. Finally, “exemplary” indicates the description is used as an example, rather than implying that it is an ideal. Other implementations of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A device comprising:
a ytterbium-doped silica glass that is laser cooled using anti-Stokes fluorescence and doped with one or more codopants and with a ytterbium density of up to including 4 wt %.

2. The device of claim 1, wherein the ytterbium -doped silica glass is laser cooled at a wavelength of about 1020 nm to about 1100 nm.

3. The device of claim 1, wherein the ytterbium -doped silica glass has an external quantum efficiency of at least 97% to allow for laser cooling.

4. The device of claim 1 wherein the one or more codopants comprise aluminum (Al), fluorine (F), phosphorus (P), cerium (Ce), germanium (Ge), or tin (Sn).

5. The device of claim 4, wherein the codopants are grouped in a first group of Al and P, a second group of Al and F, and a third group of Al, F, and Ce, and all other combinations and subcombinations, and including germanium (Ge) and tin (Sn).

6. A method for laser cooling rare earth doped silica glass using anti-Stokes fluorescence, the method comprising:
providing radiation from a laser at an appropriate wavelength to a first surface and through a body of the rare earth doped silica glass, wherein the rare earth doped silica glass is doped with one or more codopants.

7. The method of claim 6, wherein the continuous wave laser is tuned by:
tuning the laser from a first wavelength to a second wavelength;
monitoring the rare earth doped silica glass using a thermally sensitive device during the tuning; and
determining a third wavelength between the first wavelength and the second wavelength where the rare earth doped silica glass is maximumly or near maximumly cooled based on the monitoring.

8. The method of claim 6, wherein the thermally sensitive device comprises a thermal camera or a thermometer or other methods of the temperature measurement.

9. The method of claim 6, wherein the one or more rare earth elements comprise cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y).

10. The method of claim 6, wherein the one or more rare earth elements is ytterbium with a density of up to including 4 wt %.

11. The method of claim 6, wherein the rare earth-doped silica glass with ytterbium has an external quantum efficiency of at least 97% to allow for laser cooling.

12. The method of claim 6, wherein the codopants are grouped in a first group of Al and P, a second group of Al and F, and a third group of Al, F, and Ce, and all other combinations and subcombinations, and including germanium (Ge) and tin (Sn).

13. A method for laser cooling rare earth doped silica glass using anti-Stokes fluorescence, the method comprising:
providing radiation from a laser to a first surface and through a body of the rare earth doped and codoped with one or more codopants silica glass;
tuning the laser from a first wavelength to a second wavelength;
monitoring the rare earth doped silica glass using a thermally sensitive device during the tuning; and
determining a third wavelength between the first wavelength and the second wavelength where the rare earth doped silica glass is maximumly or near maximumly cooled based on the monitoring.

14. The method of claim 13, wherein the silica glass is doped with one or more rare earth elements comprising cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y).

15. The method of claim 13, wherein the one or more codopants comprise aluminum (Al), fluorine (F), phosphorus (P), cerium (Ce), germanium (Ge), or tin (Sn).

16. The method of claim 13, wherein the first wavelength is around 1020 nm and the second wavelength is around 1100 nm.

17. The method of claim 13, wherein the rare earth dopant comprises ytterbium (Yb) doped at up to including 4 wt %.

18. The method of claim 13, further comprises redirecting the radiation to a second surface of the rare earth doped silica glass.

19. The method of claim 13, wherein the rare earth doped silica glass is arranged in a vacuum chamber and reduced to a pressure of about 10⁻⁶ torr.

20. The method of claim 13, wherein the rare earth doped silica glass is arranged in a multiple-pass or long path absorption cell.

21. The method of claim 13, wherein the rare earth doped silica glass is arranged in a Herriott-type multipass cell.

22. A system for laser cooling rare earth doped silica glass using anti-Stokes fluorescence, the system comprising:
a rare earth doped and codoped with one or more codopants silica glass;
a laser that provides radiation to a first surface and through a body of the rare earth doped silica glass, wherein the laser is tuned from a first wavelength to a second wavelength; and
a thermally sensitive device that captures images of the rare earth doped silica glass as the laser is tuned and determines a third wavelength between the first wavelength and the second wavelength where the rare earth doped silica glass is maximumly or near maximumly cooled.

23. The system of claim 22, wherein the silica glass is doped with one or more rare earth elements.

24. The system of claim 23, wherein the one or more rare earth elements comprise cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), or yttrium (Y).

25. The system of claim 22, wherein the one or more codopants comprise aluminum (Al), fluorine (F), phosphorus (P), cerium (Ce), germanium (Ge), or tin (Sn).

26. The system of claim 25, wherein the first wavelength is about 1020 nm and the second wavelength is 1100 nm.

27. The system of claim 23, wherein the rare earth dopant comprises ytterbium (Yb) doped at up to including 4 wt %.

28. The system of claim 23, further comprising a vacuum chamber that is reduced to a pressure of about 10⁻⁶ torr.

29. The system of claim 23, further comprising a multiple-pass or long path absorption cell.

30. The system of claim 23, further comprising a Herriott-type multipass cell.
